(19) United States
(12) Patent Application Publication
(10) Pub. No.: US 2009/0083973 A1
(43) Pub. Date: Apr. 2, 2009

(54) Wire harness weaving and termination process

(76) Inventors: David R. Peterson, Aurora, OH (US); Christopher E. Bindel, Canfield, OH (US); Nick M. Loprire, Cortland, OH (US)

Correspondence Address: DELPHI TECHNOLOGIES, INC., M/C 480-410-202, PO BOX 5052, TROY, MI, 48007, US

(21) Appl. No.: 11/904,540

(22) Filed: Sep. 27, 2007

(51) Int. Cl. H01R 43/00

(52) U.S. Cl. 29/749; 29/755

(57) ABSTRACT

A wiring assembly fixture and system, and a method for assembling wiring assemblies, are disclosed. A wiring assembly fixture includes at least two fixture blocks that are operable to retain wire adjacent a connector or a wire termination position to define lengths of wire extending between the fixture blocks. At least one of the fixture blocks is further operable to receive a wire cutting tool to cut the lengths of wire to form wire leads adjacent one of the connectors or wire termination positions. A method for assembling a wiring assembly may include positioning first and second wiring assembly connectors and weaving wire about the first and second wiring assembly connectors to define lengths of wire extending therebetween. The method may further include cutting the lengths of wire adjacent at least one of the wiring assembly connectors to form wire leads adjacent the wiring assembly connector.

### BACKGROUND

Wiring assemblies are used for connecting electrical devices in a wide variety of applications. For example, wiring assemblies may be used in virtually any application requiring electrical connections between multiple devices or assemblies, e.g., consumer electronics, refrigeration, automotive applications, etc.

Wiring assemblies may include a connector that interfaces with or “plugs in” to an electrical device. The connector may be joined with one or more additional connectors by wiring (e.g., any conductive wire, fiber optic cable, etc.), that extends between each of the connectors and that may be coupled to electrically conductive terminals positioned in the connectors. Each additional connector may plug into additional devices or systems, thereby mating the wires, optionally via the terminals, so as to place devices in electrical communication over the wires. Each connector thus provides a plurality of electrical connections to one or more other devices as defined by the wires joining the connectors. Accordingly, wiring assemblies may be used to consolidate a large number of electrical connections between multiple electrical devices into a smaller number of connectors that may be plugged in to each device. Wiring assemblies may thereby simplify assembly of electrical systems.

Known wiring assembly methods typically involve cutting or terminating bulk wire into separate lengths of wire. Each separate length of wire is subsequently inserted or plugged in to the relevant connectors and electrically coupled with terminals that may also be positioned in the connectors. This process may be automated by large machines; however such machinery is often very expensive and therefore practical only for extremely large-scale production applications. Additionally, running changes in the wiring assemblies produced by such machinery may be generally complex and require excessive maintenance or downtime. Regardless of whether the process is automated by such machines, the process of cutting individual lengths of wire and assembling them to a plurality of connectors is generally tedious, especially for applications requiring a great number of electrical connections. Further, small-gauge wire is generally difficult to handle and install to the connectors properly as a result of the fine tolerances associated with assembly and manipulation of small parts.

Accordingly, there is a need in the art for a wiring assembly process that provides a simplified method of producing wiring assemblies that is cost-effective for non-large-scale production runs and smaller-gauge wire applications.

### SUMMARY

Various examples of a wiring assembly fixture and system, and a method for assembling wiring assemblies are disclosed herein. An illustrative example of a wiring assembly fixture includes at least two fixture blocks that are operable to retain a wiring assembly connector and wire adjacent the wiring assembly connector. The fixture blocks retain wire in such a manner to define first and second lengths of wire extending between the fixture blocks. At least one of the fixture blocks is further operable to receive a wire cutting tool to cut the two lengths of wire to form two leads adjacent one of the wiring assembly connectors.

An illustrative example of a method for assembling a wiring assembly includes positioning first and second wiring assembly connectors and weaving wire about the first and second wiring assembly connectors to define first and second lengths of wire extending therebetween. The method further includes cutting the two lengths of wire adjacent at least one of the wiring assembly connectors to form two wire leads adjacent the wiring assembly connector.

### BRIEF DESCRIPTION OF THE DRAWINGS

While the claims are not limited to the illustrated examples, an appreciation of various aspects is best gained through a discussion of various examples thereof. Referring now to the drawings, illustrative examples are shown in detail. Although the drawings represent the various examples, the drawings are not necessarily to scale and certain features may be exaggerated to better illustrate and explain an innovative aspect of an example. Further, the examples described herein are not intended to be exhaustive or otherwise limiting or restricting to the precise form and configuration shown in the drawings and disclosed in the following detailed description. Exemplary illustrations of the present invention are described in detail by referring to the drawings as follows.

FIG. 1 is a perspective view of an exemplary wiring assembly fixture;

FIG. 2A is a perspective view of an exemplary fixture block for a wiring assembly fixture;

FIG. 2B is a partial section view of an exemplary wire retention feature for a wiring assembly fixture;

FIG. 2C is a second partial section view of an exemplary wire retention feature for a wiring assembly fixture;

FIG. 2D is a perspective view of the exemplary fixture block of FIG. 2A and an exemplary cutting tool, wherein a wire is woven about the fixture block and a wiring assembly connector is positioned in the fixture block;

FIG. 3 is a schematic diagram of an exemplary wiring assembly fixture;

FIG. 4 is a process flow diagram for manufacturing an exemplary wiring assembly; and

FIG. 5 is a portion of the process flow diagram of FIG. 4 shown in greater detail, according to one example.

### DETAILED DESCRIPTION

A system including a fixture for assembling wiring assemblies or harnesses and a method of producing wiring assemblies or harnesses using the fixture, are provided. A plurality of wiring termination positions may be provided on a fixture, and wiring assembly connectors may be positioned on the fixture corresponding to the wire termination positions. For example, fixture blocks may be placed on a base surface to define a wiring assembly geometry, i.e., according to an orientation of a plurality of connections between one or more devices for which the wiring assembly is intended. This may take into account various design factors such as the relative spacing between each connection or device, the gauge of the wire(s) required, the number of electrical connections required for each connector, etc. One or more wires may be woven about the wiring assembly connectors such that two or more lengths or portions of the wire(s) extend between each of the wire termination positions or wiring assembly connectors according to the desired wiring assembly geometry. The lengths of wire may then be cut or terminated adjacent each wire termination position or wiring assembly connector to create wire leads which may then be inserted into the connectors. Any wire that can be used in conjunction with wiring assemblies may be employed, e.g., insulated conductive wire, bare wire, solid core cable, woven wire, fiber optic cable, etc.

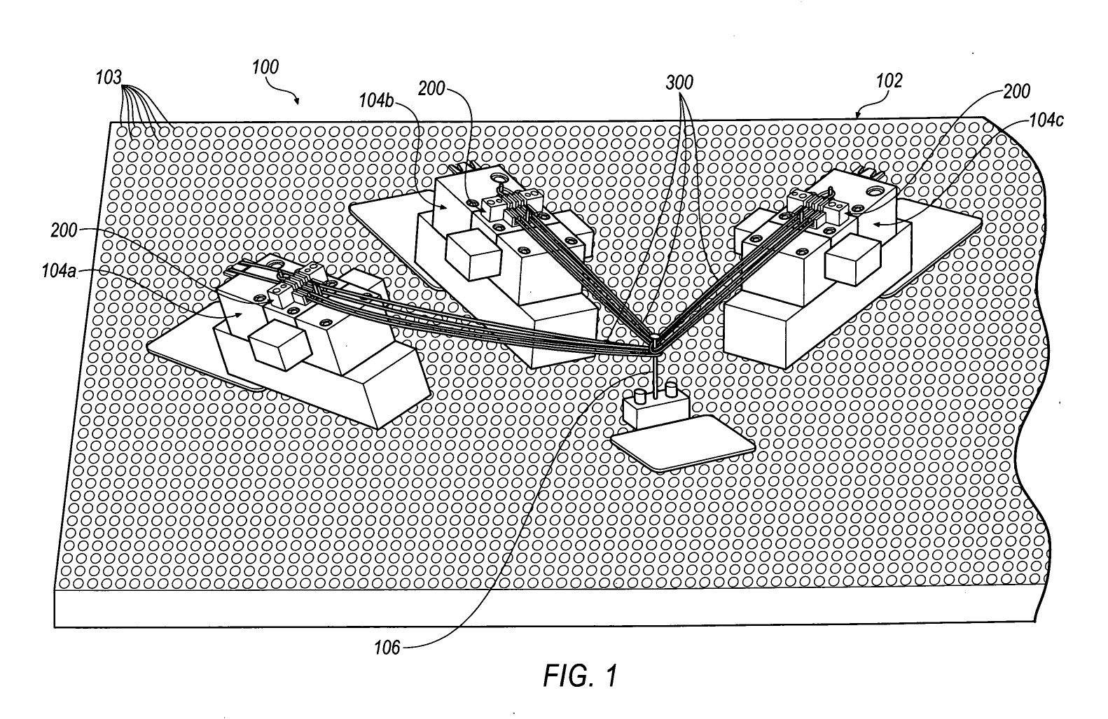

FIG. 1 illustrates an exemplary fixture 100 for constructing a wiring assembly. Fixture 100 may include a base surface 102, which generally provides a mounting surface for at least two fixture blocks 104 and a pivot pin 106. Base surface 102 includes a plurality of apertures 103 for locating fixture blocks 104. Base surface 102 may be mounted on a table or any other work surface, and hinged or otherwise disposed at any angle convenient for an operator to weave wire about fixture blocks 104. As shown in FIG. 1, fixture 100 may include three fixture blocks 104a, 104b, and 104c (collectively, 104). Fixture blocks 104 may be operable to retain at least one wiring assembly connector 200 and one or more wires 300 that are woven about fixture blocks 104 and pivot pin 106. Wires 300 may include one or more separate lengths of wire, in any wire configuration or size that can be used with wiring assembly connectors. For example, as shown in FIG. 1, wire 300 may be a generally continuous insulated conductive wire, fiber optic cable, solid core cable, etc. However, wire 300 may include separate lengths of wire, as may be useful in applications where a desired wiring assembly includes more than one gauge of wire, i.e., where a first wire having a predetermined gauge is woven about one or more fixture blocks 104, and a second wire is woven about one or more fixture blocks 104, the second wire having a different gauge than the first wire. Fixture block 104 may be used to construct wiring assemblies using wire of any size or gauge, and is capable of using smaller gauge wires or cables that are particularly inconvenient for traditional hand plugging processes, e.g., 28-32 gauge wire. Pivot pin 106 may generally abut wire 300 to define a desired angle in a length of wire 300 extending between two fixture blocks. More specifically, pivot pin 106 may abut wire 300 to form an angle of less than about 180 degrees in a length of wire 300, for example to simulate a general layout of a wiring assembly in an intended installed position for a particular application. Fixture blocks 104 are movable about base surface 102 to change the relative positions of wiring assembly connectors or wire termination positions as may be necessary. For example, as shown in FIG. 1, fixture blocks 104 and pivot pin 106 may be secured to any of the apertures 103 defined by base surface 102. Accordingly, fixture blocks 104 and pivot pin 106 may be moved about base surface 102 to define a wiring assembly geometry, as will be further described below, and may be repositioned to make alterations to the wiring assembly geometry. Generally, fixture blocks 104 may be positioned on and moved about base surface 102 to mimic or simulate a layout of a wiring assembly, e.g., an installed position of a wiring assembly between a plurality of electrical connections or devices (not shown). Accordingly, a relative spacing between the fixture blocks 104 may correspond to a relative spacing of electrical connections for which a wiring assembly is intended. The number of fixture blocks 104 and their relative spacing may be changed to suit a particular application.

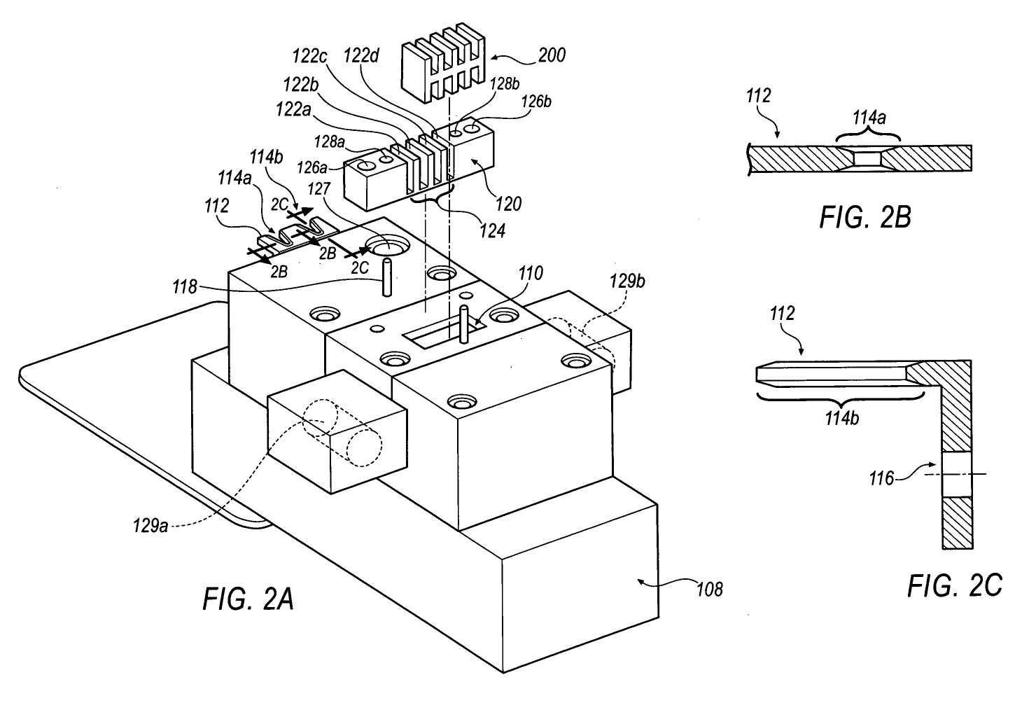

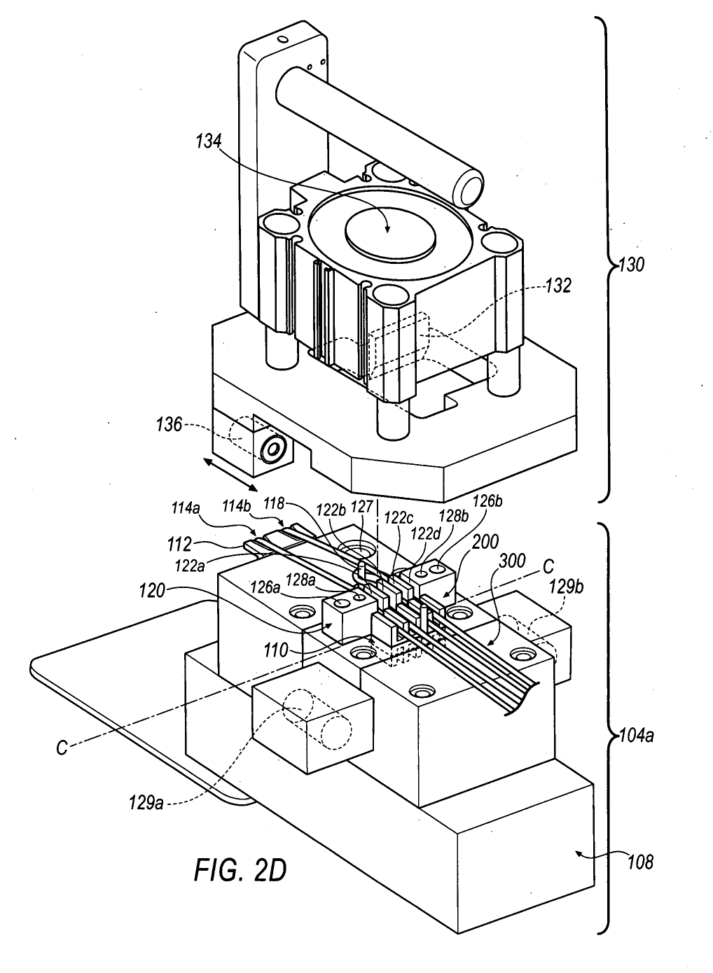

Turning now to FIGS. 2A, 2B, 2C, and 2D, fixture block 104 will be described in further detail. As shown in FIG. 2A, each fixture block 104 may include a base portion 108 that can be secured to base surface 102 (see FIG. 1). Base portion 108 is movable about base surface 102 to allow for each fixture block 104 to be adjusted to suit a variety of wiring assembly geometries. Fixture block 104 may further include a connector retaining portion 110. Connector retaining portion 110 may include any features desirable for retaining connectors 200 (shown disassembled from fixture block 104 in FIG. 2A). For example, connector retaining portion 110 may include a recess shaped to receive connector 200, thereby generally preventing movement of the connector 200.

Connector retaining portion 110 is operable to retain an insulation displacement-type connector (hereinafter IDC connector). IDC connectors may generally include a conductive portion (not shown) that displaces insulation about a conductive wire as the wire is inserted into the IDC connector, thereby placing the conductive portion of the wire in electrical communication with the IDC connector. IDC connectors conveniently allow insertion of a wire into the connector using fixture 100 and a cutting tool, as will be further described below. Any other connector that is adapted to receive wire may be employed.

Fixture block 104 includes a wire retaining or anchoring feature 112. Wire retaining feature 112 may include a post, hook, or any other retention mechanisms operable to receive wire woven about fixture block 104 and generally secure the woven wire in place, at least while wire 300 is being woven about fixture blocks 104, and/or during cutting or insertion of the wire 300 into the connector 200. For example, as shown in FIGS. 2A, 2B, and 2C, wire retaining feature 112 is a “V-block” defining two retention gaps 114a, 114b that provide an increasing interference fit with a wire 300 as it is pushed into each gap 114, thereby generally retaining the wire 300 within the gap 114. Wire retaining feature 112 may be formed integrally with fixture block 104 or, as shown in FIGS. 2A and 2C, may have an aperture 116 for receiving a fastener (not shown) to secure wire retaining feature 112 to fixture block 104. Fixture block 104 may further include a wrapping post 118 about which wire 300 may be wrapped when not retained by wire retaining feature 112, as will be described further below.

Fixture block 104 also includes a wire alignment block 120 having a plurality of grooves 122 for generally guiding the insertion of the wires into engagement with associated contacts of the connector 200. For example, as shown in FIG. 2A, the plurality of grooves 122 may include four separate grooves 122 a, b, c and d that align wire 300 with slots of a connector 200 retained by fixture block 104. Although four grooves are shown in FIG. 2A, the number of grooves may be varied according to, for example, the number of electrical connections desired for a particular wiring assembly connector. Accordingly, a wire 300 may be woven about each connector 200 that is retained by fixture block 104, as will be described below.

Turning now to FIG. 2D, fixture block 104 is shown having a connector 200 positioned within recess 110, and a wire 300 woven about fixture block 104. Wire 300 may be generally wrapped or looped about each fixture block 104 to form lengths of wire extending between the fixture blocks 104 to define a wiring assembly geometry. For example, wire 300 may be woven to form at least two lengths of wire extending from a connector 200 located on fixture block 104a to fixture block 104b (not shown in FIG. 2D) or fixture block 104c (not shown in FIG. 2D). Wire 300 may thus form one or more loops adjacent connector 200, i.e., at a wire termination position where wire 300 is generally severed or terminated, as described further below. The wire may be cut (e.g., along cutting line C in FIG. 2D), to form two leads from the lengths of wire. Wire alignment block 120 may include a blade edge 124 along a bottom surface of each groove, such that a downward motion of wires 300 generally severs or terminates the wires. Wire alignment block 120, as shown in FIG. 2A, is secured to fixture block 104 by two threaded fasteners (not shown) received through threaded apertures 126a, 126b. Wire alignment block 120 may additionally include one or more features for aligning a cutting tool, such as gross alignment aperture 127, fine alignment apertures 128a, 128b, and horizontal alignment apertures 129a, 129b, as will be described further below.

As shown in FIG. 2D, a cutting tool 130 may be provided that interfaces with each of fixture blocks 104 to generally cut or terminate wire 300. Cutting tool 130 is generally unattached to fixture 100, and may be suspended in the vicinity of fixture 100 with a counterbalance to allow cutting tool 130 to be easily moved amongst the fixture blocks 104 by an operator to terminate wire 300. Cutting tool 130 may additionally insert the ends of wire 300 into wiring assembly connector 200 after termination, as will be described further below. Cutting tool 130 includes any tool or device for cutting each length of wire 300 extending across wiring assembly connector 200 held by fixture block 104. Cutting tool 130 may additionally include a feature integrated with the cutting tool for inserting conductive leads formed by cutting wire 300 into the wiring assembly connector. As shown in FIG. 2B, cutting tool 130 includes a wire pushing implement 132 that pushes each length of wire downward against blade edge 124 of wire alignment block 120 to sever each wire 300, and insert leads formed in the cutting process into connector 200. Cutting tool 130 may rely on any known mechanism for operating wire pushing implement 132. For example, an air cylinder 134 may force wire pushing implement 132 downward against the lengths of wire 300 extending across a connector 200 along cutting line C, thereby severing each length of wire 300 against blade edge 124 of wire alignment block 120 to form leads adjacent the wiring assembly connector 200. The ends of each of the leads may be located adjacent each connector 200, to allow for insertion after wire 300 is terminated. Cutting tool 130 may thus form leads from wire 300 and insert the leads into the connector 200, generally in a single operation. Alternatively, cutting tool 130 may include separate devices or mechanisms for terminating wires 300 and inserting the leads into connector 200 after termination. Cutting tool 130 may cut off a portion of wire 300 secured to fixture block 104, e.g., a portion of wire 300 inserted into wire retaining feature 112, a loop of wire 300 wrapped about wrapping post 118, etc., to form the wire leads.

Cutting tool 130 also includes at least one engagement feature 136 that aligns cutting tool 130 with fixture block 104 and/or also wiring assembly connector 200. Engagement feature 136 may positively engage fixture blocks 104 to align cutting tool 130 and ensure accuracy of the wire cutting process. For example, as shown in FIG. 2D, an engagement feature 136 may be a generally cylinder-shaped feature provided on either side of cutting tool 130 that moves axially into corresponding apertures 129a, 129b provided on either side of fixture blocks 104, thereby positively engaging cutting tool 130 with fixture block 104. Engagement features 136 extend to engage apertures 129 in fixture block 104 upon activating cutting tool 130. Cutting tool 130 may then deploy wire pushing implement 132 to cut wire 300 and plant the wire leads into connector 200. Cutting tool 130 may additionally include one or more additional alignment features for generally aligning or positioning cutting tool 130 for termination of wire 300, e.g., one or more pins (not shown) on a bottom surface of cutting tool 130 that are inserted into a gross alignment aperture 127 and/or fine alignment aperture(s) 128a, 128b of wire alignment block 120.

Cutting tool 130 may additionally include any variety of known devices for detecting an insertion depth or height of wire 300 within connector 200. This may be useful in embodiments where wire 300 is terminated and inserted into connector 200 generally in the same operation, and particularly in embodiments where connector 200 is an IDC connector, to ensure adequate engagement and/or electrical contact between wire 300 and connector 200.

Accordingly, fixture 100 may be used to weave wire 300 about a plurality of wiring assembly connectors 200 that may be arranged in a predetermined wiring assembly geometry with fixture blocks 104. Wire 300 may then be cut adjacent each wiring assembly connector 200 to form a plurality of leads adjacent each wiring assembly connector 200. Further, fixture 100 may be used to construct wire assemblies without connectors 200. In such embodiments, wire 300 may be woven about the fixture blocks 104, such that the wires extend between wire termination positions, e.g., approximately where each connector 200 is shown above. Accordingly, fixture 100 and a cutting tool 130 may be used to terminate wires for wiring assemblies, but need not be assembled with connectors for each set of leads.

Each wiring assembly produced with fixture 100 may be further processed or finished using tags, tape, housings for connectors 200, or other features that may be applied to the wires to generally identify each lead, or bundle a group of leads attached to a particular connector 200. For example, any known feature(s) allowing for positive engagement of the wiring assembly connectors 200 with one or more electrical devices (not shown) may be assembled with the wiring assembly connectors 200, e.g., straight connectors, right-angle connectors, etc. A wiring assembly created using fixture 100 may be adapted for a virtually limitless variety of applications.

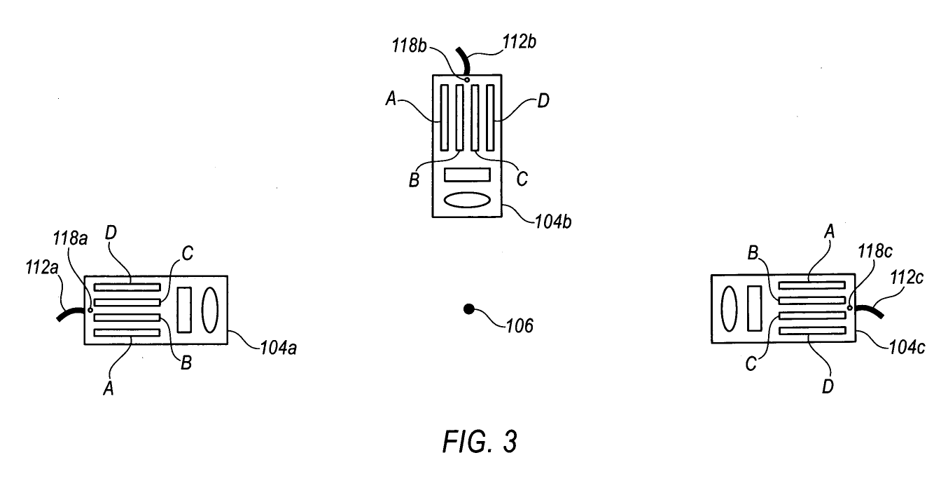

Turning now to FIG. 3, a schematic representation of fixture 100 is shown for use in describing a weaving process, as will be further described below. FIG. 3 illustrates fixture blocks 104 a, b and c that are spaced according to a predetermined wiring assembly geometry. Fixture blocks 104 a,b,c may be positioned to generally mimic or simulate a layout of three devices (not shown), which are to be placed in electrical communication by the wiring assembly. Accordingly, each fixture block 104 may generally be positioned in a similar or corresponding manner to a layout of three connections between one or more electrical devices that are to be placed in communication by the wiring assembly. Each fixture block 104 defines four slots A, B, C, and D, for receiving wire woven about fixture blocks 104 near wiring assembly connectors 200 retained by fixture blocks 104, or wire termination positions on each fixture block 104 if no connectors 200 are employed. Pivot pin 106 is also illustrated in FIG. 3. Further, wire retaining feature 112 is shown on each fixture block schematically as a single post, but may include other retention features, e.g., a V-block, etc., as described above. Fixture blocks 104 are each further illustrated with a wrapping post 118.

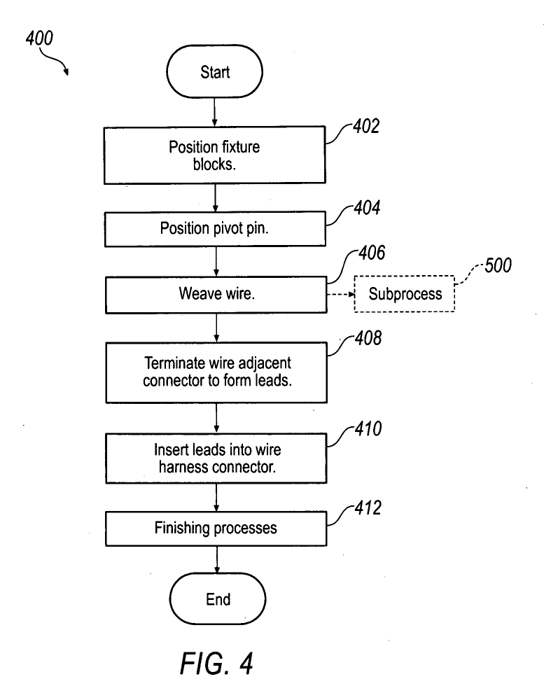

Proceeding now to FIG. 4, an exemplary process 400 for assembling a wiring assembly will be described. Process 400 begins at step 402, where a wiring assembly geometry is determined. A wiring assembly geometry may be determined by, for example, arranging fixture blocks 104 on base surface 102 according to desired wire termination positions or locations for connectors 200. Three wiring assembly connectors 200 may be installed to fixture blocks 104a,b,c, respectively, thereby fixing relative positions of connectors 200 with respect to each other, according to the desired wiring assembly geometry, as an example. Fixture blocks 104 may be positioned to define relative lengths between each fixture block 104 that correspond or represent locations of devices intended for a wiring assembly produced by process 400. Process 400 may then proceed to step 404, or may alternatively proceed directly to step 406.

In step 404, a pivot pin 106 is positioned relative to the fixture blocks 104 or wiring assembly connectors 200 positioned in step 402. For example, as described above, a pivot pin 106 may be secured to base surface 102 according to the wiring assembly geometry defined above in step 402. As described above, pivot pin 106 generally provides an engagement feature for a length of wire 300 extending between the fixture blocks 104. Process 400 then proceeds to step 406.

In step 406, one or more wires 300 is woven about each of the fixture blocks 104 to create lengths of wire 300 extending between each of the wire termination positions and/or connectors 200. Wire 300 may be received from a generally continuous supply of wire, such that a single operator may weave a generally single length of wire about each fixture block 104 as many times as is necessary to define the various electrical connections required for a specific wiring assembly geometry. Alternatively, more than one length of wire 300 may be woven about fixture blocks 104. For example, two or more separate lengths of wire 300 may be woven about fixture blocks 104 where at least two of the connections between the wire connectors 200 require different gauge wires 300.

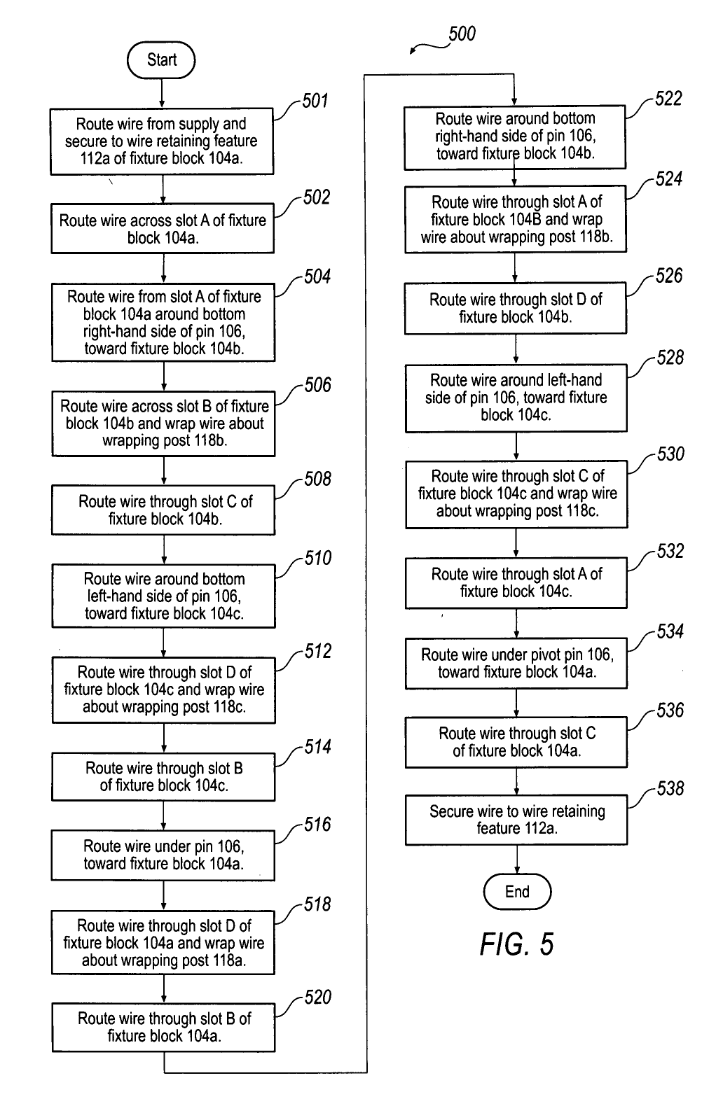

One illustrative example of the wire weaving process will now be described. Other examples may be readily ascertained from this illustrative example, modifying any variety of steps to create alternative wiring assembly geometries, including different lengths between each fixture block 104 and/or wiring assembly connector 200, number of electrical connections between each connector 200, number of wires 300 that may be woven about wiring assembly connectors 200, etc. Turning now to FIG. 5, a subprocess 500 of step 406, using the schematic layout shown in FIG. 3, describes a method of weaving wire 300 about three fixture blocks 104a,b,c, each of which has a wiring assembly connector 200 disposed thereon.

In step 501, wire 300 is fed to an operator, e.g., from a generally continuous wire supply, and an end of wire 300 may be secured to wire retaining feature 112a, e.g., a V-block as described above, of fixture block 104a. Wire 300 will be woven about the fixture blocks 104 as described further below.

In step 502, wire 300 is routed across a first slot “A” in fixture block 104a. Proceeding to step 504, wire 300 is routed from slot A of fixture block 104a around a bottom right hand side of pin 106 toward fixture block 104b. In step 506, wire 300 is routed across slot B of fixture block 104b and wrapped about wrapping post 118b of fixture block 104b, thereby forming a first length of wire 300 that extends between slot A of fixture block 104a and slot B of fixture block 104b.

Proceeding to step 508, wire 300 is routed back across fixture block 104b, through slot C. In step 510, wire is routed from slot C of fixture block 104b around a bottom left hand side of pin 106 toward fixture block 104c. In step 512, wire is routed through slot D of fixture block 104c and wrapped about wrapping post 118c of fixture block 104c, thereby forming a second length of wire 300 extending between slot C of fixture block 104b and slot D of fixture block 104c.

Proceeding to step 514, wire is routed back through slot B of fixture block 104c. In step 516, wire is routed under pivot pin 106 generally towards fixture block 104a. In step 518, wire is routed back through slot D of fixture block 104a and wire 300 is wrapped about wire wrapping post 118a of fixture block 104a, thereby forming a third length of wire that extends between slot B of fixture block 104c and slot D of fixture block 104a.

Proceeding to step 520, wire 300 is routed back through slot B of fixture block 104a. In step 522, wire 300 is routed around a bottom right hand side of pin 106, toward fixture block 104b. In step 524, wire 300 is routed through slot A of fixture block 104b and wrapped about wrapping post 118b of fixture block 104b, thereby forming a fourth length of wire 300 between slot B of fixture block 104a and slot A of fixture block 104b.

Proceeding to step 526, wire 300 is routed back through slot D of fixture block 104b. In step 528, wire 300 is routed around a left hand side of pivot pin 106, generally toward fixture block 104c. In step 530, wire 300 is routed through slot C of fixture block 104c and wrapped about wrapping post 118c of fixture block 104c, thereby forming a fifth length of wire 300 that extends between slot D of fixture block 104b and slot C of fixture block 104c.

Next, in step 532, wire 300 is routed back through slot A of fixture block 104c. In step 534, wire 300 is routed back under pivot pin 106 generally towards fixture block 104a. In step 536, wire is routed across fixture block 104a, and through slot C. In step 538, conductive wire is inserted to wire retaining feature 112a of fixture block 104a, thereby forming a sixth length of conductive wire extending between slot A of fixture block 104c and slot C of fixture block 104a. After process 500 is completed, six lengths of wire 300 extend between fixture blocks 104, as generally shown in FIG. 1. As shown in FIG. 1, each of the six lengths of wire 300 have a length of the same approximate distance, as the fixture blocks 104 are generally spaced equidistantly. Alternatively, some lengths of wire 300 may define different distances than other lengths. For example, fixture block 104c could be spaced further apart from fixture block 104a than fixture block 104b, such that a length of wire 300 extending between fixture blocks 104a and 104c would be longer in distance than a second length of wire 300 extending between fixture block 104a and fixture block 104b.

Accordingly, in step 406, a single wire 300 may be generally looped around each fixture block 104, for example as illustrated above in subprocess 500. Any size or configuration of conductive wire may be employed. In particular, small gauge wire that may be difficult to insert directly into a connector using prior art methods, e.g., 26 to 30 gauge wire, may be used in this process. However, any wire gauge desired may generally be employed. Further, conductive wire may be woven automatically with additional equipment, e.g., robotics. Moreover, wire 300 need not be continuously woven from a single wire, and more than one type of wire 300 may be woven about fixture block 104a and pivot pin 106. Use of more than one wire 300 may be convenient, for example, where multiple wire gauges are desired for certain connections between any of the wiring assembly connectors 200. Turning back to FIG. 4, process 400 then proceeds to step 408.

In step 408, one or more of the lengths of wire 300 extending between fixture blocks 104 may be terminated to form leads. For example, cutting tool 130 may be received at each fixture block 104 in sequence to generally cut off a portion of each section of wire woven about each fixture block 104, thereby forming wire leads that are disposed adjacent each connector 200 or wire termination position. Severed portions or loops of wire 300 may be discarded. Where connectors 200 are employed, cutting tool 130 cuts each length of wire 300 to form conductive leads adjacent the relevant slot of a connector 200, into which the conductive lead may be inserted, as described below. In some known examples, process 400 then proceeds to step 410, or may alternatively proceed to step 412, or may alternatively terminate.

In step 410, which is optional, the conductive leads formed adjacent each wiring assembly connector in step 508 are inserted into each wiring assembly connector. For example, as described above, a wire pushing implement 132 of cutting tool 130 may generally push each conductive lead into the connector 200, generally immediately after cutting wire 300 by pushing wire 300 downward against blade edge 124 of wire alignment block 120. In some known examples, process 400 then proceeds to step 412. Alternatively, process 400 may terminate.

In step 412, which is optional, any finishing steps may be performed, such as adding a connector cap, wire covering, identification tags, etc., as described above, to generally complete the assembly of the wiring assembly. Process 400 may then terminate.

Accordingly, fixture 100 and process 400 generally allow for assembly of wiring assemblies using a simplified process. Fixture 100 may be used to assemble wiring assemblies from one or more lengths of wire, and may advantageously be used with any size wire. Conveniently, fixture 100 and process 400 allow for use of relatively small wire gauges, generally reducing a packaging space associated with the wiring assembly. Further, modifications to a wiring assembly produced by fixture 100 and process 400 are generally easily made, as the relative spacing of fixture blocks 104 and/or pivot pin 106 may be moved to generally mimic a layout of devices intended for the wiring assembly, without redesigning the assembly process entirely or requiring new equipment, software, etc.

Reference in the specification to “one embodiment” or “an embodiment” means that a particular feature, structure, or characteristic described in connection with the embodiment is included in at least one embodiment. The phrase “in one embodiment” in various places in the specification does not necessarily refer to the same embodiment each time it appears.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A wiring assembly system, comprising:
a fixture, including:
a base surface; and
at least two fixture blocks secured to said base surface, said fixture blocks each operable to retain a connector and wire adjacent said connector to define first and second lengths of said wire extending between said fixture blocks, at least one of said fixture blocks operable to receive a wire cutting tool to cut said first and second lengths of wire to form two wire leads adjacent one of said wiring assembly connectors.

2. The wiring assembly system of claim 1, each of said fixture blocks having a respective position, said respective positions defining a wiring assembly geometry.

3. The wiring assembly system of claim 1, further comprising a wire cutting tool.

4. The wiring assembly system of claim 3, wherein said cutting tool includes a wire pushing implement that cooperates with a cutting edge of said one of said fixture blocks to cut said first and second lengths of wire.

5. The wiring assembly system of claim 3, wherein said wire cutting tool is operable to insert said two wire leads into said one of said wiring assembly connectors.

6. The wiring assembly system of claim 1, wherein said first length of wire is equal to said second length of wire.

7. The wiring assembly system of claim 1, wherein said first length of wire is different than said second length of wire.

8. The wiring assembly system of claim 1, wherein said fixture blocks are operable to retain said wire in a loop and said at least one of said fixture blocks is operable to receive the wire cutting tool to cut a portion of said loop to form said two wire leads.

9. A wire harness assembly system, comprising:
a base surface;
at least two fixture blocks mounted to said base surface, at least one of said at least two fixture blocks comprising:
a wire retaining feature operable to receive one or more wires woven about said fixture block;
a connector receiving portion adapted to receive a connector; and
a wire cutting tool configured to terminate said one or more wires.

10. The wire harness assembly system of claim 9, wherein each of said at least two fixture blocks has a respective position, said respective positions defining a wiring assembly geometry.

11. The wire harness assembly system of claim 10, wherein a position of at least one of said at least two fixture blocks is adjustable with respect to the other of said at least two fixture blocks.

12. The wire harness assembly system of claim 9, wherein said wire cutting tool is further configured to insert said one or more wires into a connector.

13. The wire harness assembly system of claim 12, wherein at least one of said at least two fixture blocks further includes a wire alignment block for guiding the insertion of said one or more wires into said connector.

14. A method of assembling a wiring assembly, comprising:
weaving wire about first and second wiring assembly connectors to define first and second lengths of wire extending therebetween; and
cutting said first and second lengths of wire adjacent at least one of said wiring assembly connectors to form two wire leads adjacent said at least one of said wiring assembly connectors.

15. The method of claim 17, further comprising positioning said first and second wiring assembly connectors to define a wiring assembly geometry.

16. The method of claim 17, further comprising inserting each of said leads into said first and second wiring assembly connectors.

17. The method of claim 17, further comprising providing first and second fixture blocks for retaining said first and second wiring assembly connectors, respectively.

18. The method of claim 20, wherein cutting said first and second lengths of wire includes receiving a cutting tool with one of said first and second fixture blocks, wherein said cutting tool cuts inserts said two leads into said at least one of said wiring assembly connectors.

19. The method of claim 20, further comprising securing said first and second fixture blocks to a base surface, said first fixture block spaced a predetermined distance away from said second fixture block to define said wiring assembly geometry.

20. The method of claim 17, wherein weaving said wire includes forming a loop of wire about at least one of said wiring assembly connectors, and said cutting said first and second lengths of wire includes cutting off a portion of said loop.

21. A method of assembling a wiring assembly, comprising:
weaving one or more wires about first, second, and third wire termination positions to define first and second lengths of wire extending from each wire termination position; and
cutting said first and second lengths of wire adjacent each of said wire termination positions to form two wire leads adjacent each of said wire termination positions;
wherein said wire termination positions define a wiring assembly geometry.

22. The method of claim 24, further comprising providing first, second, and third connectors adjacent each wire termination position, wherein said wiring assembly geometry generally mimics a relative spacing between three connections defined by one or more devices, said connectors operable to interface with the three connections.
